(19) United States
(12) Patent Application Publication
(10) Pub. No.: US 2016/0286023 A1
(43) Pub. Date: Sep. 29, 2016

(54) METHOD AND DEVICE FOR LOADING USER INTERFACE THEME

(71) Applicant: Xiaomi Inc., Beijing (CN)

(72) Inventors: Donghai Huo, Beijing (CN); Dejia Chen, Beijing (CN); Cai Zhu, Beijing (CN)

(21) Appl. No.: 14/960,450

(22) Filed: Dec. 7, 2015

(30) Foreign Application Priority Data
Mar. 23, 2015 (CN) 201510127975.5

(51) Int. Cl. H04M 1/725; H04W 4/00; G06F 3/0484

(52) U.S. Cl. CPC H04M 1/72525; G06F 3/0484; H04W 4/003

(57) ABSTRACT

The present disclosure relates to a method and a device for loading a user interface (UI) theme in an intelligent terminal. The method includes: detecting an operation instruction of a user to the intelligent terminal; determining whether an application module exists in a downloaded theme package according to the operation instruction, wherein the application module corresponds to the operation instruction. The method further includes: loading the application module to the intelligent terminal if it is determined that the application module exists.

### CROSS-REFERENCE TO RELATED APPLICATIONS

This application is based on and claims priority to Chinese Patent Application No. 201510127975.5, filed on Mar. 23, 2015, the entire contents of which are incorporated herein by reference.

### TECHNICAL FIELD

The present disclosure generally relates to the Internet field, and more particularly, to a method and a device for loading a user interface (UI) theme.

### BACKGROUND

The inventors have noted that with the increasing individual requirement of the intelligent phone, recent developments are now directed towards to the method for providing theme packages with various formats through a theme application program (theme app). In the process of downloading the theme package through the theme app and loading the theme package to the intelligent phone, there are several steps. The steps might include: downloading the theme package through the theme app; decompressing the compression package of the theme package to obtain a plurality of compression subpackages. Each compression subpackage corresponds to one application module. The steps might further include copying each compression subpackage to a corresponding resource catalog in the intelligent phone; and modifying the theme configuration in the intelligent phone.

Thus, the inventors have observed that, before the theme package is loaded and applied in the intelligent phone, the whole process might consume a large amount of time to decompress, copy and merge the theme package, as a result, the user might waste a lot of time waiting.

### SUMMARY

In some embodiments, a method for loading a UI theme in an intelligent terminal is provided. The method includes: detecting an operation instruction of a user to the intelligent terminal; determining whether an application module exists in a downloaded theme package according to the operation instruction, wherein the application module corresponds to the operation instruction. The method further comprises loading the application module to the intelligent terminal if it is determined that the application module exists.

In some embodiments, a device for loading a UI theme is provided, and the device includes: a processor; and a memory for storing instructions executable by the processor. The processor is configured to: detect an operation instruction of a user to the intelligent terminal; determine whether an application module exists in a downloaded theme package according to the operation instruction, wherein the application module corresponds to the operation instruction. The processer is further configured to load the application module to the intelligent terminal if it is determined that the application module exists.

In some embodiments, a non-transitory computer-readable storage medium stores instructions. Wherein the instructions, when executed by one or more processors of an intelligent terminal, cause the intelligent terminal to perform a method for loading a UI theme. The method comprises: detecting an operation instruction of a user to the intelligent terminal; determining whether an application module exists in a downloaded theme package according to the operation instruction, wherein the application module corresponds to the operation instruction; loading the application module to the intelligent terminal if it is determined that the application module exists.

It is to be understood that both the foregoing general description and the following detailed description are exemplary and explanatory only.

### BRIEF DESCRIPTION OF THE DRAWINGS

The accompanying drawings, which are incorporated in and constitute a part of this specification, illustrate embodiments consistent with the invention and, together with the description, serve to explain the principles of the embodiments.

FIG. 1A is a schematic diagram showing an example of a UI theme according to some embodiments;

FIG. 1B is a schematic diagram showing another example of the UI theme according to some embodiments;

FIG. 1C is a schematic diagram showing another example of the UI theme according to some embodiments;

FIG. 1D is a schematic diagram showing another example of the UI theme according to some embodiments;

FIG. 1E is a schematic diagram showing another example of the UI theme according to some embodiments;

FIG. 1F is a schematic diagram showing an example of another UI theme according to some embodiments;

FIG. 1G is a second schematic diagram showing another example of the another UI theme according to some embodiments;

FIG. 2 is a flow chart showing an embodiment of a method for loading a UI theme;

FIG. 3 is a flow chart showing another embodiment of a method for loading a UI theme;

FIG. 4 is a flow chart showing another embodiment of a method for loading a UI theme;

FIG. 5 is a block diagram showing an apparatus for loading a UI theme according to some embodiments;

FIG. 6 is block diagrams showing another apparatus for loading a UI theme according to some embodiments;

FIG. 7 is a block diagram showing a device for loading a UI theme according to some embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

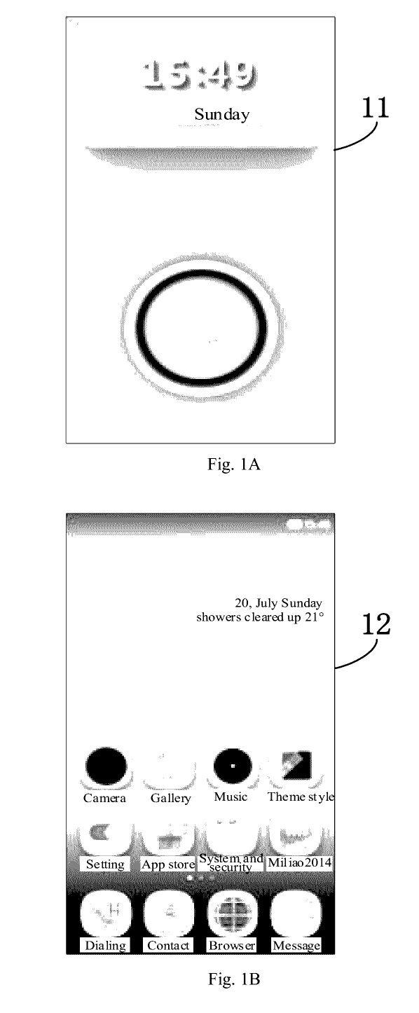

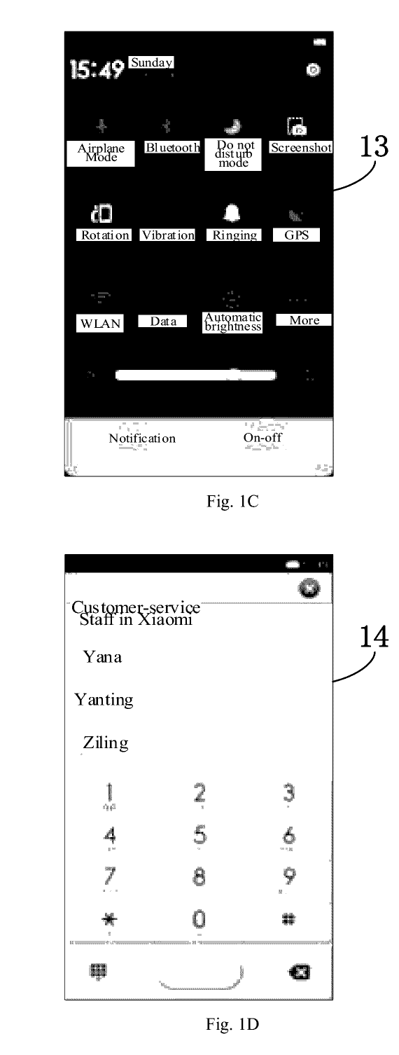

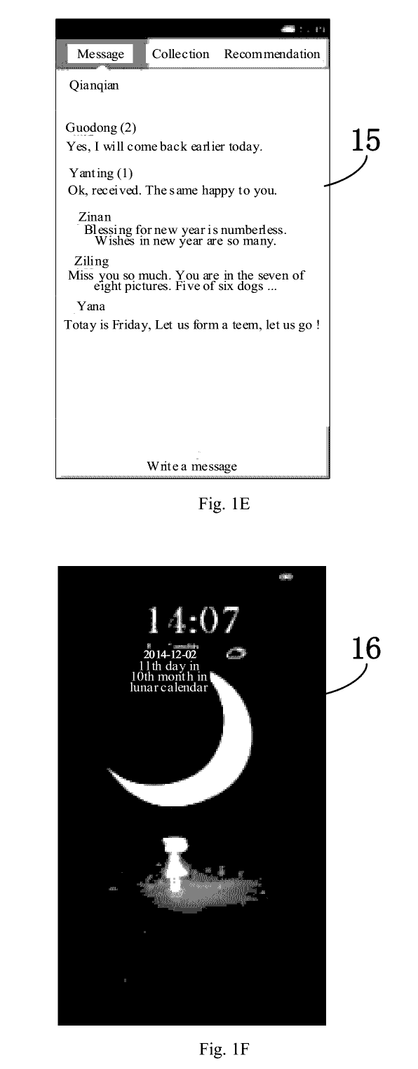

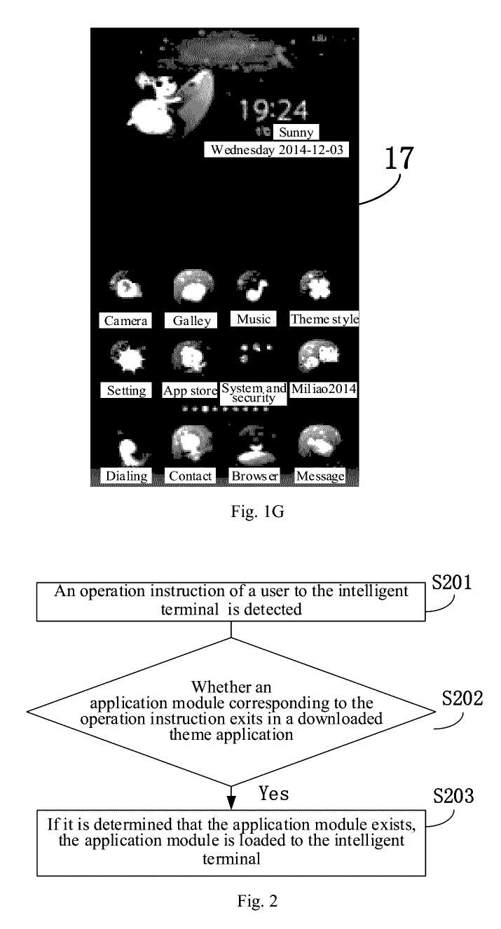

As shown in FIGS. 1A-1E, a UI theme named “Sunny” shows various appearances on an intelligent terminal. There are a plurality of application modules (such as a screen module, a desktop module, a state bar module, etc.) included in a theme package for one UI theme. For example, in FIG. 1A, when the intelligent terminal is in a lock screen state, a screen module of the theme package shows an appearance. In FIG. 1B, a desktop module of the theme package shows an appearance on the desktop of the intelligent terminal. With the desktop module of the theme package for the UI theme “Sunny”, the interface and icons are shown on the desktop of the intelligent terminal according to configuration parameters set by the desktop module. In FIG. 1C, a status bar module of the theme package shows an appearance on the intelligent terminal. In FIG. 1D, a contact list module of the theme package shows an appearance on the intelligent terminal. In FIG. 1E, a message module of the theme package shows an appearance on the intelligent terminal.

As shown in FIGS. 1F-1G, another UI theme named “Mailafent-memories of moonlight” shows two appearances on the intelligent terminal. There are also several application modules (such as a screen module, a desktop module, a state bar module, etc.) included in the theme package for the UI theme “Mailafent-memories of moonlight”. Specifically, in FIG. 1F, when the intelligent terminal is in a lock screen state, a screen locking module of the theme package shows an appearance. In FIG. 1G, a desktop module of the theme package shows an appearance on the desktop of the intelligent terminal. With the desktop module of the theme package “Mailafent-memories of moonlight”, the interface and icons are shown on the desktop of the intelligent terminal according to configuration parameters set by the desktop module.

From FIGS. 1A-1G, the theme package in accordance with the present embodiment, may be referred to as a series of templates displayed to the user by the application modules in the intelligent terminal, and the theme package includes application modules, such as, the desktop module of the intelligent terminal, icons corresponding to the applications, the status bar module, the screen locking module, etc.. It is understood by those skilled in the art that, by downloading different theme packages (such as, the above theme package for the UI theme “Sunny”, the theme package for the UI theme “Mailafent-memories of moonlight”) from a theme app, the intelligent terminal may display appearances of different styles. The schematic diagrams shown by FIGS. 1A-1G are merely exemplary, but should not be interpreted as limitations on the present disclosure.

FIG. 2 is a flow chart showing a method for loading a UI theme according to an embodiment. The method may be applied in an intelligent terminal (such as, an intelligent phone, a tablet PC). In this embodiment, exemplary descriptions are made with reference to FIGS. 1A-1G. As shown in FIG. 2, the method includes steps S201-S203, as will be detailed below.

In step S201, an operation instruction of a user to the intelligent terminal is detected.

In an embodiment, the operation instruction of a user to the intelligent terminal may be an operation instruction of re-opening the intelligent terminal after the user closes the intelligent terminal, an operation instruction of releasing by the user the intelligent terminal which is in the lock screen state, an operation instruction of opening by the user the message application on the touched screen of the intelligent terminal, an operation instruction of opening by the user the contact list application on the touched screen of the intelligent terminal, etc. That is, the operation instruction of a user to the intelligent terminal may be an operation instruction trigged by any action on the intelligent terminal from the user.

In step S202, it is determined whether an application module exits in a downloaded theme package according to the operation instruction, wherein the application module corresponds to the operation instruction.

For example, assuming that the user has downloaded the theme package for the UI theme “Sunny” through a theme app, or that the user is downloading the theme package for the UI theme “Sunny” through the theme app and some application modules of the theme package for the UI theme “Sunny” have been downloaded and other application modules of the theme package for the UI theme “Sunny” have not yet been downloaded. If it is determined that the operation instruction of the user to the intelligent terminal is an operation instruction of releasing the intelligent terminal which is in the lock screen state, firstly it is determined whether the releasing module of the theme package for the UI theme “Sunny” is downloaded.

In step S203, if it is determined that the application module exists, the application module is loaded to the intelligent terminal.

For example, if it is determined that the releasing module of the theme package for the UI theme “Sunny” is downloaded, the releasing module of the theme package for the UI theme “Sunny” is loaded to the intelligent terminal. Once the operation instruction of the user to the intelligent terminal is detected, the application module corresponding to the operation instruction is loaded, thus, the application module may be loaded according to the interaction of the user and the intelligent terminal.

As illustrated above, the corresponding application module is loaded according to the operation instruction of a user to the intelligent terminal. Accordingly, the theme package is applied in the intelligent terminal without wasting a large amount of time on decompressing, copying and merging the theme package by the intelligent terminal, thus, the user's waiting time of using the theme package is reduced.

In some embodiments, the method may further include: sending a first download instruction with a first priority to a theme app installed on the intelligent terminal, if it is determined that the application module corresponding to the operation instruction does not exist; downloading the application module with the first priority through the theme app according to the first download instruction.

Details about loading the UI theme may be obtained with reference to following embodiments.

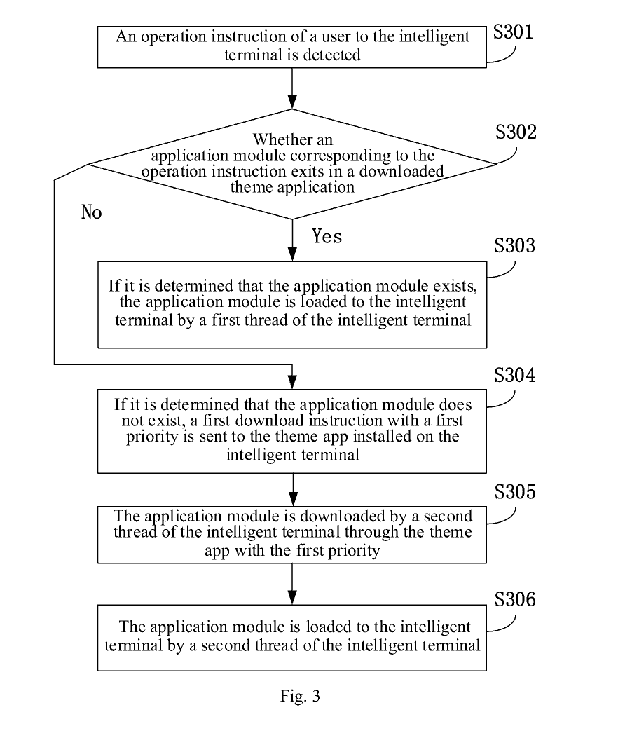

FIG. 3 is a flow chart showing a method for loading a UI theme according to an embodiment. Along with FIGS. 1A-1E, how the application modules of the theme package is loaded through a theme app is illustrated. As shown in FIG. 3, the method includes following steps.

In step S301, an operation instruction of a user to the intelligent terminal is detected.

Step S301 is substantially the same as that detailed above with respect to step S201 of FIG. 2, which will not be addressed.

In step S302, it is determined whether an application module corresponding to the operation instruction exits in a downloaded theme package according to the operation instruction. If the application module corresponding to the operation instruction exists, step S303 is executed. If the application module corresponding to the operation instruction does not exist, step S304 is executed.

Similar to step S202, step S302 will not be addressed.

In step S303, if it is determined that the application module corresponding to the operation instruction exists, the application module is loaded by a first thread of the intelligent terminal to the intelligent terminal, and then the procedure is finished.

Similar to step S203, step S303 will not be addressed.

In step S304, if it is determined that the application module corresponding to the operation instruction does not exist, a first download instruction with a first priority is sent to the theme appl installed on the intelligent terminal.

In some embodiments, the first priority of the first download instruction may be the highest priority, or a priority set according to the importance of application module. If the first priority is the highest priority, the application module corresponding to the operation instruction is downloaded to the intelligent terminal as soon as possible, thus, the user's waiting time of using the theme resource related to the operation instruction may be greatly reduced.

In step S305, the application module is downloaded by a second thread of the intelligent terminal through the theme app with the first priority.

In step S306, the first thread is initiated to load the application module to the intelligent terminal.

For example, if it is detected that the operation instruction of the user to the intelligent terminal is a releasing operation, then it is determined whether the releasing module corresponding to the releasing operation exists in the downloaded theme package for the UI theme “Sunny.” If it is determined that the releasing module corresponding to the releasing operation exists, the releasing module is loaded to the intelligent terminal by the first thread of the intelligent terminal. If it is determined that the releasing module corresponding to the releasing operation does not exist, the releasing module is downloaded through the theme app by the second thread of the intelligent terminal, and is loaded to the intelligent terminal by the first thread. In this way, the releasing module is loaded by the first thread, or downloaded by the second thread, thus, that the parallelization of loading the application module and downloading the application module is implemented.

As illustrated above, the application module of the theme package is downloaded by the first thread of the intelligent terminal through the theme app to the intelligent terminal, and the downloaded application module is loaded by the second thread of the intelligent terminal to the intelligent terminal, such that the parallelization of downloading and loading is implemented, thus the user's waiting time of using the theme resource related to the operation instruction is greatly reduced.

In some embodiments, the method for loading a UI theme further includes: detecting whether a second download instruction about the theme package exists in a theme app installed on the intelligent terminal; downloading the theme package via a second thread in the intelligent terminal if the second download instruction about the theme package exists. Wherein downloading the theme package via a second thread in the intelligent terminal includes: determining download priorities corresponding to application modules in the theme package; downloading the application modules in the theme package in an order determined according to the download priorities corresponding to the application modules.

In some embodiments, the method may further include: displaying an indication indicating that the theme package is successfully loaded after any application module in the theme package is downloaded.

Thus, in a situation where the intelligent device works normally, or the indication light is still on, the indication light can be switched off by a remote control. Accordingly, the dazzling feeling of the user due to the indication light is avoided. Accordingly, the user has a good rest and use electricity safely indoor, and the convenience for a family home is improved.

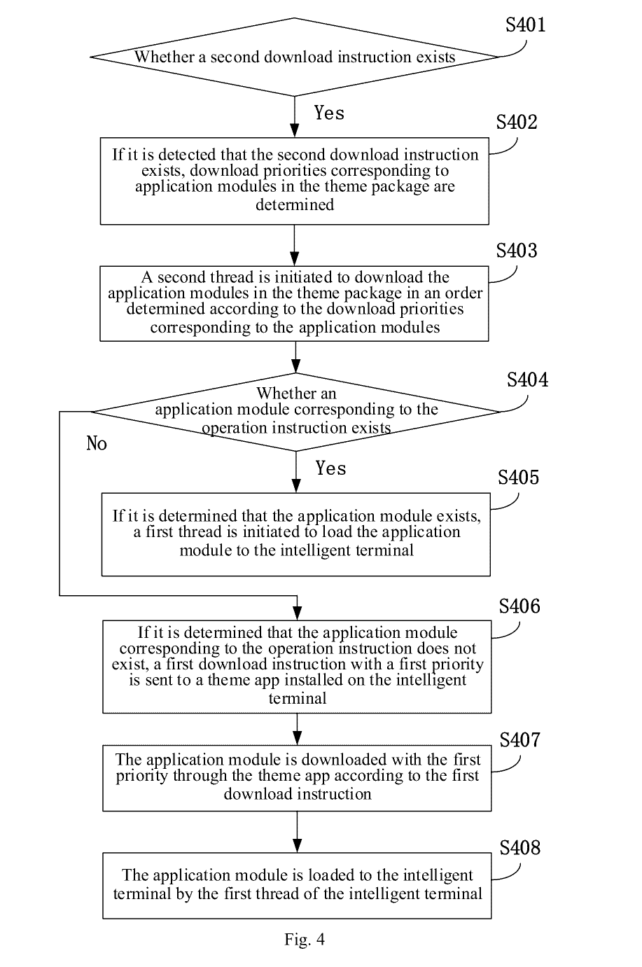

FIG. 4 is a flow chart showing a method for loading a UI theme according to an embodiment. In this embodiment, how the download priorities of application modules in the theme package is adjusted is illustrated. Along with FIGS. 1A-1E, the above-mentioned method provided by the embodiments of the present disclosure is explained exemplarily. As shown in FIG. 4, the method includes following steps.

In step S401, it is detected whether a second download instruction regarding the theme package exists in a theme app installed on the intelligent terminal.

In step S402, if it is detected that the second download instruction regarding the theme package exists, download priorities corresponding to application modules in the theme package are determined.

In step S403, a second thread is initiated to download the application modules in the theme package according to the download priorities corresponding to the application modules.

In step S404, in the process of downloading the theme package, if an operation instruction of a user to the intelligent terminal is detected, it is determined whether an application module corresponding to the operation instruction exists in the downloaded theme package according to the operation instruction. If it is determined that the application module corresponding to the operation instruction exists, step S405 is executed. If it is determined that the application module corresponding to the operation instruction does not exist, step S406 is executed.

In step S405, if it is determined that the application module corresponding to the operation instruction exists, a first thread is initiated to load the application module to the intelligent terminal, and the procedure is finished.

In step S406, if it is determined that the application module corresponding to the operation instruction does not exist, a first download instruction with a first priority is sent to a theme app installed on the intelligent terminal.

In step S407, the application module is downloaded with the first priority through the theme app according to the first download instruction, and then the procedure is finished.

In step S408, the first thread of the intelligent terminal is initiated to load the application module to the intelligent terminal.

For example, if a download instruction of downloading the theme package for the UI theme “Sunny” is detected in the theme app, the download priorities corresponding to the application modules (such as, the desktop module, the screen locking module, the setting module, etc.) in the downloaded theme package for the UI theme “Sunny” are determined. The download priorities may be, for example, first downloading the desktop module, then downloading the screen locking module, and then downloading the setting module with the above download priorities. When an operation instruction of opening the message application from the user is detected, then it is determined whether the message module corresponding to the operation instruction of opening the message application exists in the downloaded theme package according to the operation instruction of opening the message application.

If it is determined that the message module corresponding to the operation instruction of opening the message application exists, the first thread is initiated to load the message module of the theme package for the UI theme “Sunny” to the intelligent terminal. If it is determined that the message module corresponding to the operation instruction of opening the message application does not exist, the first download instruction with the first priority is sent to the theme app installed on the intelligent terminal, and the application module is downloaded with the first priority through the theme app according to the first download instruction. The first priority may be higher than each of the download priorities in step S402, thus, the message module of the theme package for the UI theme “Sunny” is downloaded preferentially. Accordingly, the time caused by downloading the message module of the theme package for the UI theme “Sunny” to the intelligent terminal by the preset priority is reduced.

As illustrated above, the downloading and loading of the application module are implemented by a downloading thread and a loading thread, respectively. The application module is downloaded according to a preset priority. In the loading process, it is determined, according to the operation instruction from the user, whether the corresponding application module is downloaded with the first priority through the theme app. Thus, the parallelization of downloading and loading is achieved, accordingly, the user's waiting time of using the theme resource related to the operation instruction is realty reduced.

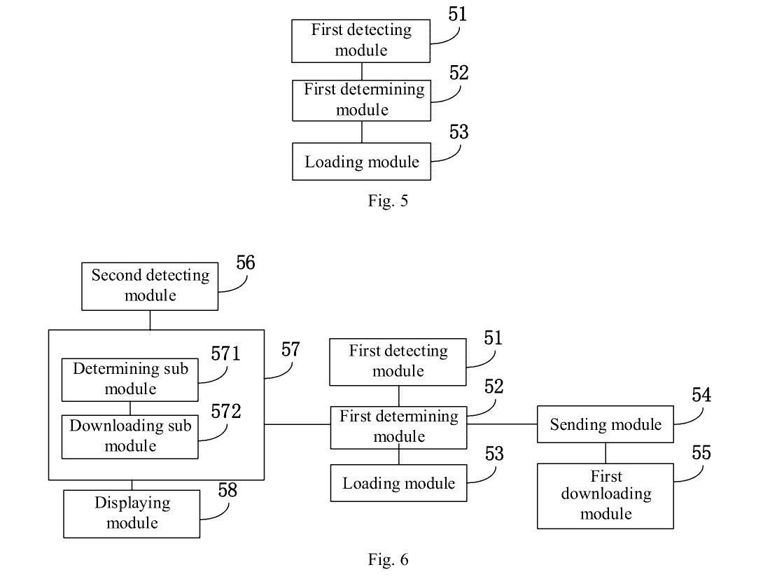

FIG. 5 is a block diagram showing an apparatus for loading a UI theme according to an exemplary embodiment. The apparatus is applied in an intelligent terminal. As shown in FIG. 5, the apparatus includes a first detecting module 51, a first determining module 52 and a loading module 53.

The first detecting module 51 is configured to detect an operation instruction of a user to the intelligent terminal.

The first determining module 52 is configured to determine whether an application module corresponding to the operation instruction exists in a downloaded theme package according to the operation instruction detected by the first detecting module 51.

The loading module 53 is configured to load the application module to the intelligent terminal, if the first determining module 52 determines that the application module corresponding to the operation instruction exists.

FIG. 6 is block diagrams showing another apparatus for loading a UI theme according to an exemplary embodiment. Based on the embodiment illustrated in FIG. 5, the apparatus may further include a sending module 54, a first downloading module 55.

The sending module 54 is configured to send a first download instruction with a first priority to a theme app installed on the intelligent terminal, if the first determining module 52 determines that the application module corresponding to the operation instruction does not exist.

The first downloading module 55 is configured to download the application module with the first priority through the theme app according to the first download instruction sent by the sending module 54.

In some embodiments, the apparatus may further include a second detecting module 56 and a second downloading module 57.

The second detecting module 56 is configured to detect whether a second download instruction regarding the theme package exists in a theme app installed on the intelligent terminal.

The second downloading module 57 is configured to download the theme package if the second detecting module 56 detects that the second download instruction about the theme package exists, such that the first determining module 52 may determine whether the application module corresponding to the operation instruction exists in the downloaded theme package.

In some embodiments, the second downloading module 57 may include a determining sub module 571, a downloading sub module 572.

The determining sub module 571 is configured to determine download priorities corresponding to application modules in the theme package corresponding to the second download instruction detected by the second detecting module 56.

The downloading sub module 572 is configured to download the application modules in the theme package in an order determined according to the download priorities corresponding to the application modules determined by the determining sub module 571.

In an embodiment, the apparatus may further include a displaying module 58.

The displaying module 58 is configured to display an indication that the theme package is successfully loaded after any application module in the theme package is downloaded by the second downloading module 57.

Concerning the implementation process of the function and action of each modules of the apparatus above, reference is made to the implementation process of corresponding steps in the above method, which will not be addressed.

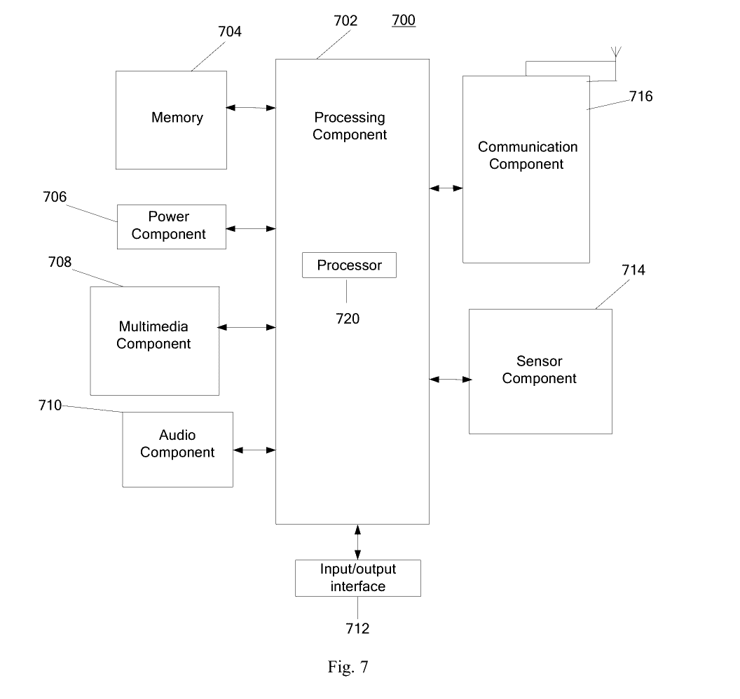

FIG. 7 is a block diagram showing a device for loading a UI theme according to an exemplary embodiment. For example, the device 700 may be a mobile phone, a computer, a digital broadcast terminal, a messaging device, a gaming console, a tablet, a medical device, exercise equipment, a personal digital assistant, and the like.

Referring to FIG. 7, the device 700 may include one or more of the following components: a processing component 702, a memory 704, a power component 706, a multimedia component 708, an audio component 710, an input/output (I/O) interface 712, a sensor component 714, and a communication component 716.

The processing component 702 typically controls overall operations of the device 700, such as the operations associated with display, telephone calls, data communications, camera operations, and recording operations. The processing component 702 may include one or more processors 720 to execute instructions to perform all or part of the steps in the above described methods. Moreover, the processing component 702 may include one or more modules which facilitate the interaction between the processing component 702 and other components. For instance, the processing component 702 may include a multimedia module to facilitate the interaction between the multimedia component 708 and the processing component 702.

The memory 704 is configured to store various types of data to support the operation of the device 700. Examples of such data include instructions for any applications or methods operated on the device 700, contact data, phonebook data, messages, pictures, video, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 provides power to various components of the device 700. The power component 706 may include a power management system, one or more power sources, and any other components associated with the generation, management, and distribution of power in the device 700.

The multimedia component 708 includes a screen providing an output interface between the device 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and the rear camera may receive an external multimedia datum while the device 700 is in an operation mode, such as a photographing mode or a video mode. Each of the front camera and the rear camera may be a fixed optical lens system or have focus and optical zoom capability.

The audio component 710 is configured to output and/or input audio signals. For example, the audio component 710 includes a microphone (MIC) configured to receive an external audio signal when the device 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, such as a keyboard, a click wheel, buttons, and the like. The buttons may include, but are not limited to, a home button, a volume button, a starting button, and a locking button.

The sensor component 714 includes one or more sensors to provide status assessments of various aspects of the device 700. For instance, the sensor component 714 may detect an open/closed status of the device 700, relative positioning of components, e.g., the display and the keypad, of the device 700, a change in position of the device 700 or a component of the device 700, a presence or absence of user contact with the device 700, an orientation or an acceleration/deceleration of the device 700, and a change in temperature of the device 700. The sensor component 714 may include a proximity sensor configured to detect the presence of nearby objects without any physical contact. The sensor component 714 may also include a light sensor, such as a CMOS or CCD image sensor, for use in imaging applications. In some embodiments, the sensor component 714 may also include an accelerometer sensor, a gyroscope sensor, a magnetic sensor, a pressure sensor, or a temperature sensor.

The communication component 716 is configured to facilitate communication, wired or wirelessly, between the device 700 and other devices. The device 700 can access a wireless network based on a communication standard, such as WiFi, 2G, or 3G, or a combination thereof. In one exemplary embodiment, the communication component 716 receives a broadcast signal or broadcast associated information from an external broadcast management system via a broadcast channel. In one exemplary embodiment, the communication component 716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 704, executable by the processor 720 in the device 700, for performing the above-described methods. For example, the non-transitory computer-readable storage medium may be a ROM, a RAM, a CD-ROM, a magnetic tape, a floppy disc, an optical data storage device, and the like.

Other embodiments will be apparent to those skilled in the art from consideration of the specification and practice of the disclosure disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present disclosure is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for loading a user interface (UI) theme in an intelligent terminal, comprising:
detecting an operation instruction of a user to the intelligent terminal;
determining, according to the operation instruction, whether an application module exists in a downloaded theme package, wherein the application module corresponds to the operation instruction; and
loading the application module to the intelligent terminal if it is determined that the application module exists.

2. The method according to claim 1, further comprising:
sending a first download instruction with a first priority to a theme application program (theme app) if it is determined that the application module does not exist, wherein the theme app is installed on the intelligent terminal; and
downloading, according to the first download instruction, the application module through the theme app with the first priority.

3. The method according to claim 1, wherein the theme package is downloaded by:
detecting whether a second download instruction regarding the theme package exists in the theme app; and
downloading the theme package if the second download instruction regarding the theme package exists.

4. The method according to claim 3, wherein downloading the theme package comprises:
determining download priorities, wherein the download priorities correspond to application modules in the theme package; and
downloading, according to the download priorities, the application modules in the theme package.

5. The method according to claim 4, further comprising:
displaying an indication that the theme package is successfully loaded after any application module in the theme package is downloaded.

6. The method according to claim 2, wherein the intelligent terminal comprises a first thread configured to load the application module to the intelligent terminal and a second thread configured to download the application module through the theme app.

7. A device for loading a user interface (UI) theme, comprising:
a processor; and
a memory for storing instructions executable by the processor,
wherein the processor is configured to:
detect an operation instruction of a user to the intelligent terminal;
determine, according to the operation instruction, whether an application module exists in a downloaded theme package, wherein the application module corresponds to the operation instruction; and
load the application module to the intelligent terminal if it is determined that the application module exists.

8. The device according to claim 7, wherein the processor is configured to:
send a first download instruction with a first priority to a theme application program (theme app) if it is determined that the application module does not exist, wherein the theme app is installed on the intelligent terminal; and
download, according to the first download instruction, the application module through the theme app with the first priority.

9. The device according to claim 7, wherein the theme package is downloaded by:
detect whether a second download instruction regarding the theme package exists in the theme app; and
download the theme package if the second download instruction regarding the theme package exists.

10. The device according to claim 9, wherein the processor is configured to download the theme package by acts of:
determining download priorities, wherein the download priorities correspond to application modules in the theme package; and
downloading, according to the download priorities, the application modules in the theme package.

11. The device according to claim 10, wherein the processor is further configured to:
display an indication that the theme package is successfully loaded after any application module in the theme package is downloaded.

12. The device according to claim 8, wherein the processor comprises a first thread configured to load the application module to the intelligent terminal and a second thread configured to download the application module through the theme app.

13. A non-transitory computer-readable storage medium storing instructions, when executed by one or more processors of an intelligent terminal, which cause the intelligent terminal to perform a method for loading a user interface (UI) theme, the method comprising:
detecting an operation instruction of a user to the intelligent terminal;
determining, according to the operation instruction, whether an application module exists in a downloaded theme package, wherein the application module corresponds to the operation instruction; and
loading the application module to the intelligent terminal if it is determined that the application module exists.

14. The non-transitory computer-readable storage medium according to claim 13, wherein the method further comprises:
sending a first download instruction with a first priority to a theme application program (theme app) if it is determined that the application module does not exist, wherein the theme app is installed on the intelligent terminal; and
downloading, according to the first download instruction, the application module through the theme app with the first priority.

15. The non-transitory computer-readable storage medium according to claim 13, wherein the theme package is downloaded by:
detecting whether a second download instruction regarding the theme package exists in the theme app; and
downloading the theme package if the second download instruction regarding the theme package exists.

16. The non-transitory computer-readable storage medium according to claim 15, wherein downloading the theme package comprises:
determining download priorities, wherein the download priorities corresponds to application modules in the theme package;
downloading, according to the download priorities, the application modules in the theme package.

17. The non-transitory computer-readable storage medium according to claim 16, wherein the method further comprises:
displaying an indication that the theme package is successfully loaded after any application module in the theme package is downloaded.

18. The non-transitory computer-readable storage medium according to claim 14, wherein the intelligent terminal comprises a first thread configured to load the application module to the intelligent terminal and a second thread configured to download the application module through the theme app.
